(19) United States
(12) Patent Application Publication
(10) Pub. No.: US 2026/0242619 A1
(43) Pub. Date: Aug. 20, 2026

(54) DISPOSABLE LINER COATING, METHOD OF OBTAINING THE SAME AND USES THEREOF

(71) Applicant: KIINNS FOODTECH LTD, Kfar Vradim (IL)

(72) Inventors: Ehud FURMAN, Nesher (IL); Tzvi FURMAN, Kfar Vradim (IL); Avram IACUBOVICI, Haifa (IL); Roni EFRATI, Kiryat Tivon (IL)

(21) Appl. No.: 18/874,503

(22) PCT Filed: Jun. 12, 2023
(86) PCT No.: PCT/IL2023/050601

§ 371 Date: Dec. 12, 2024

Related U.S. Application Data
(60) Provisional application No. 63/351,600, filed on Jun. 13, 2022.
(60) Provisional application No. 63/482,433, filed on Jan. 31, 2023.

(51) Int. Cl. C09D 5/20; B32B 43/00; C09D 5/03; C09D 5/26; C09D 7/80; C09D 167/02

(52) U.S. Cl. CPC C09D 5/20; B32B 43/006; C09D 5/031; C09D 5/033; C09D 5/26; C09D 7/80; C09D 167/02

(57) ABSTRACT

The present disclosure provides a thermoplastic powder, a method of preparing the thermoplastic powder, uses of the powder for forming a removable thermoplastic liner over a metal or metal containing substrate and to methods of removing the removable liner from the substrate. The powder comprises in each of its grains a blend of components, at least one component comprising an aliphatic/aromatic copolyester (AAPE); the powder is suitable for being electrostatically sprayed onto a metal substrate or metal containing substrate and for forming onto said metal substrate a molten liner coating that is reversibly fixed to the substrate.

### TECHNOLOGICAL FIELD

The present disclosure relates to disposable liner coating material for use in industry.

### BACKGROUND ART

References considered to be relevant as background to the presently disclosed subject matter are listed below:
International Patent Application Publication No. WO 2017/125913
International Patent Application Publication No. WO2020/222227
International Patent Application Publication No. WO06/097354
U.S. Pat. No. 4,398,0222
U.S. Pat. No. 4,966,959

Acknowledgement of the above references herein is not to be inferred as meaning that these are in any way relevant to the patentability of the presently disclosed subject matter.

### BACKGROUND

In the industry, fluids and solids processing and transportation is performed in a variety of equipment units and such processing unavoidably requires cleaning of internal surfaces and/or working surfaces of the processing equipment.

Aside from high operational costs involved in cleaning the equipment each time, there are also safety risks involved due to improper cleaning, and all the more, high negative impact on the environment as a result of the huge water waste and organic and chemical waste being generated during the cleaning processes that flow to the sewage or the environment.

WO 2017/125913 generally describes a disposable layer adapted to shield a working surface from coming into contact with, and being fouled by, processed liquids and/or solids, and apparatus suitable to apply a negative pressure in a gap between the disposable layer and the working surface, to thereby causing said disposable layer to adhere to said working surface.

WO2020/222227 describes a system for the in situ production (manually or automatically) of a liner suitable to shield active surfaces of apparatus for the processing of liquids and/or solids from coming into contact with, and being fouled by, processed materials. The system comprises a spray head, adapted to spray a layer of curable polymeric material onto a surface; a material supply system, power and control units-adapted to direct the movement of the spray head according to data pertaining to the surface geometry to be sprayed; and curing apparatus, suitable to cure the layer of material sprayed onto said surface, thereby to produce a shielding liner in situ.

Copolyesters for use in the formation of films are described, inter alia, in WO06/097354, U.S. Pat. Nos. 4,398,0222 and 4,966,959.

### GENERAL DESCRIPTION

The present disclosure provides, in accordance with a first of its aspects a thermoplastic powder comprising in each grain a blend of components, at least one component comprising an aliphatic/aromatic copolyester; wherein the powder is suitable for being electrostatically sprayed onto a metal or metal containing substrate and for forming onto said metal or metal containing substrate a molten liner coating that is reversibly fixed to the substrate.

Also provided by the present disclosure, in accordance with a second of its aspects, is a method of preparing the thermoplastic powder comprising in each grain a blend of components, at least one component comprising an aliphatic/aromatic copolyester; the method comprising providing pellets comprising a homogenous blend of components, at least one component comprising an aliphatic/aromatic copolyester and subjecting the pellets to at least one cryogenic milling step to obtain said thermoplastic powder grains.

In accordance with a third of its aspects, the present disclosure provides an article comprising a metal or metal containing element having an exposed surface and a thermoplastic liner coating reversibly fixed to the exposed surface, the thermoplastic liner coating comprising a blend of components, at least one component comprising an aliphatic/aromatic copolyester; said liner coating maintains its fixation and integrity over the exposed surface upon application of a processing stress imposing a force on said liner.

In accordance with a fourth of its aspects, the present disclosure provides a method of removing a thermoplastic liner from a metal or metal containing substrate, the thermoplastic liner comprising a blend of components, at least one component comprising an aliphatic/aromatic copolyester, the method comprises any one or combination of:
connecting the substrate to a negative pole of an Alternating Current (AC) Radio Frequency (RF) generator and subjecting the substrate to an AC field, while removing the thermoplastic liner from the substrate;
injecting pressurized gas into pre-fabricated channels between the substrate and the liner causing at least partial detachment of the liner from said substrate, and removing the at least partially detached liner from the substrate;
heating the liner to a temperature below melting temperature of the blend of components; and
cooling the liner to a temperature below the glass transition temperature of at least one component of the liner. The glass transition temperature of each of the components of the liner can be determined using, e.g. Differential Scanning calorimetry (DSC);
exposing the liner to a food compatible acid.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1E are images of steps involved in bowl liner coating according to a non-limiting example of the present disclosure, including the bowl before coating (FIG. 1A); bowl being subjected to electrostatic spraying (FIG. 1B); sprayed bowl being heated using IR heater applied from different directions (FIGS. 1C-1D); and the eventually liner coated bowl (FIG. 1E).

FIGS. 2A-2D are images showing manual peeling of a bowl coated with a liner according to an example of the present disclosure (FIG. 2A); partially peeled bowl (FIG. 2B), mechanically peeling of a ruler like substrate, the liner shown by the arrow (FIG. 2D), or partially peeled ruler like substrate, the partially removed liner shown by the arrow (FIG. 2C).

FIGS. 3A-3C are images showing the performance of a kitchen mixer's bowl coated with a liner in accordance with an example of the present disclosure, and including the liner coated bowl mounted onto a kitchen mixer, before use (FIG. 3A), during kneading of dough (FIG. 3B) and after the dough was removed (FIG. 3C).

FIGS. 4A-4C are images showing the application of an electric field to facilitate reduction of adhesion forces by applying an electric field between the positively charged electrode (“P”) and the negatively charged bowl (“N”) as shown in FIG. 4A or by applying IR energy (~80° C.) to the fully coated bowl) as shown in FIG. 4B and the removed liner after the IR energy application, as shown in FIG. 4C.

### DETAILED DESCRIPTION

The present disclosure is based on the understanding that there is a need to provide a solution to food safety issues and environmental pollution that can be created from traditional washing of industrial equipment in the food industry that are considered to present safety risks and provide a negative environmental impact.

The present disclosure is also based on the understanding that a same solution is needed in other industries, such as cosmetics, polymer synthesis industry, pharmaceutical industry, mineral production industry and any other industry that requires or involves mixing of different components in different batches with the same equipment. To eliminate or minimize drawbacks of washing industrial equipment, a technology has been developed and is herein disclosed that involves the formation of a reversibly fixed liner adhered to relevant parts of the equipment and upon completion of work, the liner is easily removed from the equipment without the further need to wash the working surface thereof. The ability to provide a reversibly fixed liner resides, inter alia, in the properties of the powder forming the liner, the method of forming the liner and the methods of removing the liner.

Thus, in the broadest aspects of the present disclosure, there are provided a thermoplastic powder for forming the liner, a method of forming the powder, a method of forming the liner from the powder, articles comprising the liner reversibly adhered to the article's surface, preferably metal substrate or metal containing substrate, and methods of removing the liner.

Specifically, and in accordance with a first of its aspects, there is provide a thermoplastic powder comprising a plurality of grains, each grain comprising a blend of components, at least one component comprising at least one component comprising an aliphatic/aromatic copolyester (AAPE); wherein the powder is suitable for being electrostatically sprayed onto a metal substrate or metal containing substrate and for forming onto the substrate a continuous liner coating that is reversibly fixed to the substrate.

In some examples of the presently disclosed subject matter, the powder suitable for being electrostatically sprayed onto a metal substrate or metal containing substrate comprises or consists essentially of polymeric grains having a grain size between 50 μm and 200 μm.

When referring to size it is to be understood to refer to the largest dimension of the grains measured along any direction of the grain.

In some examples of the presently disclosed subject matter, the grains in the powder have specifically selected dimensions.

In some examples the grains are at least 50 μm in size. When referring to a size of at least 50 μm it is to be understood to encompass grains that would not pass a mesh having a nominal opening size equal or below 50 μm.

In some examples, the grains have dimensions that would not pass a mesh having a nominal opening size of at least 55 μm; at times, of at least 60 μm; at times, of at least 65 μm; at times, of at least 70 μm; at times, of at least 75 μm.

In some examples the grains are at most 200 μm. When referring to a size of up to 200 μm it is to be understood to encompass grains that would pass a mesh having a nominal opening size of equal or at most 200 μm.

In some examples, the plurality of grains have dimensions of at most 190 μm; at times, of at most 180 μm; at times, of at most 170 μm; at times, of at most 160 μm; at times, of at most 150 μm; at times, of at most 140 μm; at times, of at most 130 μm; at times, of at most 120 μm; at times, of at most 110 μm; at times, of at most 100 μm.

In some examples of the presently disclosed subject matter, the powder suitable for being electrostatically sprayed onto a metal substrate or metal containing substrate is characterized by a density of about 1±0.3 gr/cm³.

In some examples of the presently disclosed subject matter, the powder suitable for being electrostatically sprayed onto a metal substrate or metal containing substrate is characterized by the presence of grains with an irregular shape. The term “irregular shape” denotes any shape other than spherical, and preferably denotes shapes having one or more sharp edges.

In some examples of the presently disclosed subject matter, the powder suitable for being electrostatically sprayed onto a metal substrate or metal containing substrate is characterized by a combination of any of the definitions, e.g. size of between about 50 μm and 100 μm, and/or a population of grains were at least 50% have a size of less than 150 μm, and/or a density of about 1±0.3 gr/cm³ and/or irregular shape.

In some examples the liner is a continuous cohesive liner adhered/fixed to the metal substrate or metal containing substrate.

In some examples of the presently disclosed subject matter, the liner is a continuous liner, namely, with no gaps or holes within the liner that could allow transfer of material (e.g. liquids, solids) from one side of the liner to another side thereof.

In some examples of the presently disclosed subject matter, the liner is a cohesive liner, namely, essentially one-piece coating over the substrate.

The thermoplastic powder disclosed herein may comprise a single co-polymer or a combination of polymers and/or co-polymers.

In the context of the present disclosure, when referring to a co-polyester it is to be understood to have its meaning as known in the art, i.e. a modification of a polyester, which is a combination of diacids and diols, the modification includes the introduction of other diacids and/or other diols.

In some examples of the presently disclosed subject matter, the powder comprises grains that are an essentially homogenous blend of its components. Thus, the plurality of grains forming the powder include in each grain essentially the same composition/combination of components, at essentially the same ratio.

In some examples of the presently disclosed subject matter, the plurality of grains (i.e. the powder) are characterized by the existence, in at least part of the grains, of one or more sharp edges.

Without being bound by theory, it has been concluded by the inventors that grain size and/or density and/or shape as explained above are essential for the effective electrostatically spraying of the powder onto the metal or metal containing substrate to form on the surface of the substrate a reversibly adhered liner, as further described hereinbelow.

The size and shape of the grains defines its surface area, and hence its charging level at an electrostatic spraying gun head and its motion characteristics under an electrostatic field between such an electrostatic spraying gun and the metal containing substrate. A grain's shape, physical area and cross section would also affect the grain's aerodynamic behavior and trajectory under turbulent driving air stream created inside the electrostatic gun's head. For example, grains below 50 μm would create flour-like cloud that would not adequately follow the desired field lines direction, i.e. would be uncontrollable. The grain's dimension also defines its mass; hence its gravitational behavior under all forces acting on the grain. Grain size and shape would also determine the effectiveness of heat absorption and unification of neighboring melted grains. Thus, it has been envisaged that the size and shape of the grains are independently essential to achieve optimal powder buildup on the surface of the metal containing substrate, under the electrostatic spraying, and for its efficient phase (solid to molten) transformation into a continuous cohesive liner.

In some examples, the shape of the grains also affects the liner functionality. In some examples, at least 50% of the grains have an irregular shape/non-spherical shape as viewed by an optical microscope.

The substrate is one that at least contains metal (metal containing substrate).

In the context of the present disclosure, when referring to metal containing substrate it is to be understood to encompass metal substrates, where the liner is directly adhered to a metal surface or a metal containing surface, and also to substrates that contain metal but the liner is not necessarily directly in contact with the metal. For example, a metal containing substrate can be a layered substrate including at least two layers, a first layer configured to be in contact with the liner and that is made of a synthetic (e.g. plastic) material and a distal metal layer. The layers do not necessarily need to be attached one to another and can be in close proximity. When in a layered configuration, the substrate can be considered to be a dielectric substrate with a metal backing (attached to the layer proximal to the liner or in close proximity thereto).

In some examples, the substrate is a stainless-steel substrate.

The AAPE composition of the powder and its dimensions make the powder of the present disclosure suitable for being electrostatically sprayed onto a metal substrate or a metal containing substrate and for forming on the metal substate a continuous liner, as noted above.

The continuous liner is “reversibly fixed” onto the substate. In the context of the present disclosure, when referring to a reversibly fixed or reversibly adhered liner it is to be understood to mean that after electrostatic spraying the powder and heating the sprayed powder using IR heater, and obtaining a liner on the surface of the sprayed substrate, the liner is adhered onto the substrate such that under operational conditions of the substrate (as further explained below), the liner is essentially fixed in its place and intact, i.e. without causing any damage to the integrity, continuity and/or cohesiveness of the liner. Yet, when applying a suitable trigger, the liner can be effectively removed from the substate, preferably without being disintegrated/ruptured/torn, undesirably leaving parts of the liner on to substrate.

In some examples, the extent of fixation can be defined by the minimal force required to peel the liner without its breaking or tearing into pieces. In some examples, a fixed liner is defined as one that requires for its effective removal from the surface of the substrate a force of at least 2N/inch, when the liner has a thickness of about 200 μm (when measured at room temperature), and in some other examples, the removal force may be even greater than 4N/inch, when the liner has a thickness of about 50 μm. A person skilled in the art would be able to determine the force range, depending inter alia, on the liner thickness.

The aliphatic/aromatic copolyester (AAPE) may be more specifically defined by its components. In some examples, the AAPE comprises (a) an acid component comprising repeating units of a (i) polyfunctional aromatic acid and (ii) an aliphatic or cycloaliphatic acid; and (b) a diol component.

In the context of the present disclosure, when referring to a “polyfunctional aromatic acid” it is to be understood to encompass aromatic dicarboxylic compounds. In some examples, the dicarboxylic compounds are of the phthalic-acid type and their esters.

In one particular example, the dicarboxylic compound is terephthalic acid.

In some examples, when referring an “aliphatic or cycloaliphatic acid” it is to be understood to encompass any C₂-C₂₀ aliphatic or cycloaliphatic hydroxyl or dicarboxylic acid; at times, any C₄-C₁₆ aliphatic or cycloaliphatic hydroxyl or dicarboxylic acid.

A non-limiting list of aliphatic acids that are dicarboxylic acids include brassylic acid, sebacic acid, azelaic acid, glutaric acid, malonic acid, glycolic acid, pimelic acid, 1,12-dodecanedioic acid and adipic acid.

A non-limiting list of aliphatic acids that are hydroxy acids include hydroxybutyric acid, hydroxycaproic acid, hydroxyvaleric acid, 7-hydroxyheptanoic acid, 8-hydroxycaproic acid, 9-hydroxynonanoic acid, lactic acid and lactide.

The diol component (dialcohol) in the powder is, in accordance with some examples, an aliphatic diol, preferably, a C₂-C₁₀ aliphatic diol, particularly C₂-C₄ diols.

In some examples, the aliphatic diol is selected from the group consisting of diethylene glycol, 1, 2-ethandiol, 1, 2-propandiol, 1, 3-propandiol, 1, 4-butandiol, 1, 5-pentandiol, 1, 6-hexandiol, 1, 7-heptandiol, 1, 8-octandiol, 1, 9-nonandiol, 1, 10-decandiol, 1, 11-undecandiol, 1, 12-dodecandiol, 1, 13-tridecandiol, 1, 4-cyclohexandimethanol, propylene glycol, neo-pentyl glycol, 2-methyl-1, 3-propandiol, dianhydrosorbitol, dianhydromannitol, dianhydroiditol, cyclohexandiol, and cyclohexanmethandiol

In some examples, the aliphatic diol is 1,4-butandiol.

In some examples, the thermoplastic powder also comprises, as part of the grains' blend, at least one biodegradable polymer.

In some examples, the biodegradable polymer is from natural source.

In some examples, the biodegradable polymer from natural source is selected from the group consisting of starch, cellulose, chitosan, alginates and natural rubbers, including any modified forms of the former.

In some examples, the biodegradable polymer is selected from modified starche and/or modified cellulose, such as, without being limited thereto, starch or cellulose esters with a degree of substitution of between 0.2 and 2.5; hydroxypropylated starches; and modified starches with fatty chains.

In some examples, the biodegradable polymer of natural source is starch.

In some examples, the biodegradable polymer is from synthetic source.

In some examples, the biodegradable polymer from synthetic source is selected from the group consisting of polylactic acid, poly-e-caprolactone, polyhydroxybutyrates, valerate, polyhydroxybutyrate propanoate, such as polyhydroxybutyrate-polyhydroxybutyrate-hexanoate, polyhydroxybutyrate-decanoate, polyhydroxybutyrate-dodecanoate, polyhydroxybutyrate-hexadecanoate, polyhydroxybutyrate-octadecanoate, and polyalkylene succinates.

In some examples, the biodegradable polymer of synthetic source is polylactic acid (PLA).

The grains of the powder may also comprise additional additives that can contribute to the liner formation and/or its properties.

In some examples, the additional additive is a metal oxide. Without being bound by theory, it is considered that the presence of the metal oxide contributes to the peel-ability of the liner, e.g. under a disruptive electric field, by increasing the liner's dielectric response (dielectric constant).

In some examples, the metal oxide is titanium dioxide (TiO₂).

In some other or additional examples, the metal oxide is selected from the group consisting of ferric oxide (Fe₂O₃), tantalum pentoxide (Ta₂O₅), chromium oxide (Cr₂O₃) and silicon dioxide (SiO₂).

When present in the blend, the amount of the metal oxide would be at most 10 w/w %; at times, not more than 5 w/w %; at times, not more than 4 w/w %; at times, not more than 3 w/w %; at times, not more than 2 w/w %.

In some examples, the additive comprises a phase change material (PCM). By the term “phase change material” or in short “PCM”, it is to be understood to encompass any material that can absorb, store and release thermal energy during phase transition to provide useful heat/cooling. In some examples, the PCM is an organic PCM. Non-limiting example of organic PCM is selected from the group consisting of glycerol, di and polyglycerols, ethylene or propylene glycol, ethylene and propylene diglycol, polyethylene glycol, polypropylenglycol, 1,2 propandiol, trymethylol ethane, trimethylol propane, pentaerytritol, dipentaerytritol, sorbitol, erytritol, xylitol, mannitol, sucrose, 1,3 propandiol, 1,2, 1,3, 1,4 buthandiol, 1,5 pentandiol, 1,6, 1,5 hexandiol, 1,2,6, 1,3,5-hexantriol, neopenthil glycol, and polyvinyl alcohol prepolymers and polymers, polyols acetates, ethoxylates and propoxylates, particularly sorbitol ethoxylate, sorbitol acetate, and pentaerytritol acetate.

The additive may also be any one of a plasticizer, a softener etc. or a magnetic component (such as RAMDETECT by POLYRAM).

In some examples, the additive is glycerol, acting both as a PCM and a plasticizer.

in some examples the amount of the additives is up to 20 w/w %.

The amount of the different components forming the blend may vary and the ratio between the components will dictate the eventual properties of the powder in terms of, inter alia, adhesiveness, elasticity, biodegradability, dielectric constant, etc.

In some examples, the thermoplastic powder comprises a blend of components that are each food contact approved, thus rendering the resulting liner food contact approved as well.

By the term “food contact approved” it is to be understood to have the meaning as defined by the European Union Regulation, i.e. that the components of the blend are safe to use when coming in contact with food. The blend of the grains must not release any substances into food at levels that are harmful to human health and must not change food composition, taste or odor in an unacceptable way.

In some examples, the thermoplastic powder disclosed herein, that is also food contact approved, comprises a copolyester known by the tradename EF51L, belonging to the Mater-Bi product family, produced by Novamont.

In some other examples, the thermoplastic powder disclosed herein, that is also food contact approved, comprises a copolyester known by the tradename EX52A0, belonging to the Mater-Bi product family, produced by Novamont.

In some other examples, the thermoplastic powder disclosed herein, that is also food contact approved, comprises a copolyester known by the tradename EF03V, belonging to the Mater-Bi product family, produced by Novamont.

In some other examples, the thermoplastic powder disclosed herein, that is also food contact approved, comprises a copolyester known by the tradename EI51C0, belonging to the Mater-Bi product family, produced by Novamont.

In some other examples, the thermoplastic powder disclosed herein, that is also food contact approved, comprises a biodegradable copolyester and polylactic acid (PLA), some known by the tradenames Ecovio® (e.g. TA1241, IS1335, F2223) or Ecoflex® (e.g. C1200), produced by BASF.

In some examples, the thermoplastic powder disclosed herein, that is also food contact approved, comprises a copolyester as described in any one of International Patent Publication No. WO06/097353, WO06/097354, WO06/097353 WO06/097355, WO06/097356 the content of which are incorporated herein by reference.

In some examples, the powder blend, that is food contact approved comprises two or more co-polyesters, at least one of which is polybutylene adipate terephthalate (PBAT).

In some examples, the powder blend, that is food contact approved comprises two or more co-polyesters, at least one being EF51L and at least one other is polybutylene adipate terephthalate (PBAT).

In the following description, when referring to EF51L it is to be understood to encompass any one of the Novamont Mater-Bi EF51L—being a biodegradable and compostable bioplastic granulate composed of corn starch, vegetable oil derivatives, and biodegradable synthetic polyesters, as described in International Patent Publication No. WO06/097353, WO06/097354, WO06/097353 WO06/097355, WO06/097356 the content of which are incorporated herein by reference. In some examples, the EF51L is defined by the combination of at least two main components, polylactic acid (PLA) and polybutylene adipate terephthalate (PBAT). These two components constitute no less than 95% of the overall composition of EF51L and the remaining components are additives used in thermoplastic compounding industry.

In some examples, the powder blend that is food contact approved comprises glycerol.

In some examples, the powder blend that is food contact approved comprises TiO₂.

The present disclosure also provides a method of preparing the herein disclosed thermoplastic powder. The method comprises providing pellets comprising a homogenous blend of components, at least one of the components comprising an aliphatic/aromatic copolyester (AAPE) and subjecting the pellets to at least one cryogenic milling step to obtain powder grains. In some examples, at least 50% of the powder grains obtained by the disclosed method have a size below 200 μm.

The components forming the powder are described hereinabove and also define the disclosed method, mutatis mutandis.

The pellets may be obtained by any method that provides a homogenous blend of the components therein.

In some examples, the pellets are obtainable by extrusion of the components.

In some examples, the pellets are obtained by extrusion of the components.

In some examples, the pellets are obtained by extrusion of the components in a twin screw extruder, operated according to manufacturer's instructions.

In some examples, the extrusion comprises subjecting the blend of components to a twin screw extruder process under conditions that permit for the homogenous mixing of the components of the blend and pelletizing the homogenous blend.

The pellets are then subjected to cryogenic milling to obtain the desired powder.

Without being bound by theory, it has been concluded by the inventors that size reduction of the pellets by cryogenic milling provides powder with irregular shapes, typically, although not exclusively, with relatively sharp edges.

Cryogenic milling can be conducted using any conventional cryomilling device. The conditions of cryogenic milling include reducing the temperature of the pellets using liquid nitrogen and then subjecting the cooled pellets to milling process(es).

Cryogenic milling may include more than one round of milling. In some examples, the method comprises two or more cryogenic milling steps, until the pellets are downsized to d50 diameter of between 50 μm and 200 μm (i.e. 50% of the grains are within the recited range).

In some examples, the milling steps are performed to provide a population of grains a d90 diameter of between 50 μm and 200 μm.

In some examples, the milling steps are performed to provide a population of grains a d90 diameter of between 50 μm and 100 μm.

In some examples, the milling steps are performed to provide a population of grains a d90 diameter of between 50 μm and 200 μm.

In some examples, the milling steps are performed to provide a population of grains a d90 diameter of between 50 μm and 150 μm.

In some examples, the milling steps are performed to provide a population of grains a d90 diameter of between 50 μm and 75 μm.

The method disclosed herein also comprises sieving the milled grains. The sieving can be performed after a single milling step, after several milling steps, and/or after each milling step.

In some examples, the sieving of the powder grains is with at least one mesh sieve with a nominal opening size equal or below 200 μm.

In some examples, the sieving of the powder grains is with at least one mesh sieve with a nominal opening size equal or below 150 μm.

In some examples, the sieving of the powder grains is with at least one mesh sieve with a nominal opening size equal or below 100 μm.

In some examples, the sieving involves passing the grains through several mesh sieves, having different nominal opening sizes.

The thermoplastic powder disclosed herein is used, inter alia, for forming a thermoplastic liner over a metal or metal containing substrate.

Thus, also disclosed herein is a method of a thermoplastic liner over a metal or metal containing substrate, the liner being reversibly adhered to the substrate, the method comprises electrostatically spraying, followed by thermal treatment/melting of a thermoplastic powder disclosed herein, on the substrate.

Without being bound by theory, it was concluded by the inventors that the cryogenic milling and formation of powder particles with irregular sharp edges contributes to the electrostatic spraying of the powder.

The spraying of the powder can be performed using any electrostatic powder coating device known in the art. In some examples, the device is an electrostatic dry powder sprayer (spraying gun) of a type/configuration that would allow approaching and spraying surfaces of different types, regardless of their geometry and/or contour.

The powder is sprayed in dry form. Without being bound by theory, it is assumed that moisture may affect the quality of spraying and of the resulting liner. For example, moisture may increase drying rates of the sprayed mass/liner as well as cause dripping/flowing of the sprayed material etc.

In some examples, the spraying is conducted when the substrate is electrically ground and the electrostatic sprayer is at a voltage of between about 30 kV and about 150 kV applied between the sprayer and the substrate. In some examples, the sprayer is operated at a voltage of between 40 kV and 130 kV; at times between 40 kV and 110 kV; at times between 50 kV and 100 kV.

The distance between the sprayer and the substrate is limited due to possible arcing between the high voltage at the gun tip and the grounded substrate. The distance typically will also determine the field shaping, the flux and the coverage rate of the powder beam. In some examples, the distance will range between 5 cm to 50 cm; at times, between 5 cm-40 cm; at times, between 10-50 cm; at times, between 10-40 cm.

Once the powder is sprayed, it is subjected to heating to form a molten.

In the context of the present disclosure, the formation of molten results from thermal treatment whereby the free thermoplastic grains being sprayed onto the surface are converted into a fluid coherent mass.

Thermal treatment and molten formation can be achieved using various techniques. In some examples, the thermal treatment is by using infra-red irradiation from, for example, ceramic and/or quartz sources.

In some examples, the thermal treatment comprises irradiation with an array of IR emitters.

In some examples, thermal treatment comprises irradiation with an array of IR emitters, at least one and preferably more than one comprising quartz IR radiation sources.

In some other examples, the thermal treatment is by using scanning laser heating. Thermal treatment can be conducted at a range of temperatures and may depend also on duration of thermal treatment. Typically, thermal treatment is conducted so as to expose the sprayed powder to a temperature at or near the melting point of the material to be melted, as determined, for example, using DSC. In some examples, a typical range would be about 120° C. and 250° C.; at times, 130° C. and 230° C.; at times 140° C. and 200° C.; at times 140° C. and 190° C.; at times 150° C. and 200° C.; at times 150° C.-180° C. and preferably, when using EF51L material, whose nominal melting point is at 167° C., a preferred range would be 160° C.-170° C.

The operation of the IR emitter would be determined so as to reach the above temperatures of the materials to be melted.

The conditions of thermal treatment result in the formation, from the sprayed powder, of a continuous cohesive liner over the substrate.

The conditions of spraying (e.g. amount of powder sprayed) and thermal treatment (e.g. temperature) may control physical properties of the liner. In other words, it is possible to control one or more physical properties of the liner, by manipulation of spraying and/or heating conditions.

In some examples, the conditions are determined or selected to provide a liner having a mean thickness within a range of 50 μm and 300 μm; at times, within a range of 60 μm and 250 μm; at times, within a range of 70 μm and 200 μm; at times, within a range of 80 μm and 180 μm; at times, within a range of 90 μm and 150 μm. In some examples, the liner's thickness is essentially not below 50 μm, where the liner would typically be difficult to remove/peel without it being torn or cracked.

In some examples, the conditions are determined or selected to provide a liner that is a continuous cohesive liner over the substrate.

In some examples, the conditions are determined or selected to provide a liner that is selectively impermeable to liquids. In this connection, it is to be understood that impermeability may depend on the intended use such that the liner is impermeable to the liquid with which it is to come into contact. For example, if the liner is to come into contact with water, the liner is designed to be water impermeable; if the liner is intended to come into contact with acidic liquids, the liner is designed to be impermeable to acidic liquids etc.

The present disclosure allows for the coating of articles of manufacture with the liner of the type described herein. Thus, also provided by the present disclosure is an article comprising a metal or metal containing element having a thermoplastic liner coating reversibly fixed to a surface of the article, the thermoplastic liner coating comprising a blend of components as disclosed herein. The liner coating on the article maintains its fixation and integrity over the article's surface even when a processing stress is applied within a predetermined range. For example, when the liner has a thickness of about 100 μm, the liner will be retained in place (without any disintegration) upon application of a force of even 4N/inch, at room temperature. Thicker liners may withstand lower detaching forces because adhesion strength is in general inversely proportional to the thickness, as it is influenced by interface stresses arising from thermal expansion coefficients difference between coating and substrate. In some examples, as noted also above, with a liner thickness of from 50 μm would require a minimal force greater than 4N/inch, for example, between 4N/inch and 6N/inch; in some other examples, a liner thickness of 200 μm would require a force above 2N/inch, for example, between 2N/inch and 3.5 N/inch.

The articles to be coated with the liner can be of any type. However, in accordance with some examples, the article is one suitable for use in industry.

In some preferred examples, the presently disclosed subject matter is for use with an article that is suitable for use in the food industry.

In some further examples, the presently disclosed subject matter is for use with an article that is suitable for use in the cosmetic industry.

In some further examples, the presently disclosed subject matter is for use with an article that is suitable for use in the polymer synthesis industry.

In some further examples, the presently disclosed subject matter is for use with an article that is suitable for use in the pharmaceutical industry.

As noted hereinabove, at some point, the liner needs to be removed from the substrate. The removal of the liner requires applying one or more triggered inputs (physical trigger) that weakens the adhesion.

The triggered input may be a triggering energy, such as an electric field, a magnetic field, Ultraviolet (UV) radiation, IR radiation, thermal shock trigger etc. The trigger may be a mechanical trigger, such as air blowing into a priori designed (fabricated) spaces/channels between the liner and the substrate, forcing detachment of the liner from the substrate.

The triggered input weakens the association/adherence between the liner and the surface, thus allowing its easy peeling off the surface, without any undesired breakdown of the liner. In other words, by applying the triggered input it is possible to peel off/remove the liner without leaving any residual liner on the substrate.

Thus, also disclosed herein are methods of removing the thermoplastic liner disclosed herein from a metal or metal containing substate to which the liner is fixed in place.

In some aspects of the presently disclosed subject matter there is provided a method of removing a thermoplastic liner from a metal or metal containing substrate, the thermoplastic liner comprising a blend of components as defined with respect to the presently disclosed thermoplastic powder, the method comprises applying a physical trigger (referred to herein, at times, by the term “triggered input”) configured to cause a change in at least the liner and pealing said liner in essentially one piece.

In the context of the present disclosure, when referring to a change in at least the liner, it is to be understood to include any change that can be a result of applying a physical trigger on the liner (directly or indirectly). The physical change can be for example change in surface energy, change in strength of adhesion, change in physical state and the like.

In some examples of the presently disclosed subject matter, the triggered input comprises at least connecting the substrate to a negative pole of an Alternating Current (AC) Radio Frequency (RF) generator and subjecting the substrate to an AC field, while removing the thermoplastic liner from the substrate.

In some examples of the presently disclosed subject matter, the triggered input comprises heating the liner to a temperature below melting temperature of the blend of components forming the liner.

In some examples of the presently disclosed subject matter, the triggered input comprises applying a thermal shock onto at least one of the liner and the substate. In some examples, the thermal shock is configured to create a temperature difference between the liner and the substrate.

In the context of the present disclosure, when referring to a temperature difference that results from a thermal shock it is to be understood to include a difference of at least 10° C.

In some examples, this temperature difference is of at least about 15° C.; at times, of at least about 20° C.; at times, of at least about 25° C.; at times, of at least about 30° C.; at times, of at least about 35° C.; at times, of at least about 40° C.; at times, of at least about 45° C.; at times, of at least about 50° C.; at times, of at least about 55° C.; at times, of at least about 60° C.; at times, of at least about 65° C.; at times, of at least about 70° C.; at times, of at least about 75° C.; at times, of at least about 80° C.; at times, of at least about 85° C.; at times, of at least about 90° C.

In some examples, this temperature difference is up to 150° C.; at times, up to about 140° C.; at times, up to about 130° C.; at times, up to about 120° C.; at times, up to about 110° C.; at times, up to about 100° C.

In some examples, this temperature difference is within a range of between about 10° C. and about 150° C.; at times, between about 20° C. and about 140° C.; at times, between about 20° C. and about 120° C.; at times, between about 30° C. and about 150° C.; at times, between about 30° C. and about 120° C.; at times, between about 40° C. and about 150° C.; at times, between about 50° C. and about 150° C.; at times, between about 50° C. and about 120° C.; at times, between about 60° C. and about 150° C.; at times, between about 60° C. and about 120° C.

In some examples of the presently disclosed subject matter, the thermal shock comprises exposing at least the liner to a temperature below the glass transition temperature of at least one component of the liner.

The non-limiting examples presented herein show that applying a thermal shock (using, for example, an iced bath, cold gas (e.g. air, nitrogen, carbon dioxide, helium) gas jet produced by Vortex gas jet, nozzle, capillary, or liquid or solid jet of carbon dioxide (e.g. liquid CO₂, such as DMX RGB 3, or e.g. solid beam of dry ice, such as SMART dry ice blaster from Direct Industry) weakened the adherence of the liner to the substrate, thereby allowed the pulling away/peeling of the liner, in one piece, and without any liner material remaining adhered to the substrate.

In some examples of the presently disclosed subject matter, the triggered input comprises connecting the substrate having fixed thereto the liner, to a negative pole of an Alternating Current (AC) Radio Frequency (RF) generator and subjecting the liner coated substrate to an AC field, while pulling away/peeling/removing the thermoplastic liner from the substrate.

The non-limiting examples presented herein show that the AC field weakened the adherence of the liner to the substrate, thereby allowing the pulling away/peeling of the liner, in one piece, and without any liner material remaining adhered to the substrate.

The effect of electric field on adhesion of thermoplastic resin against steel plates has been described [Effect of Electric Field on Adhesion of Thermoplastic Resin against Steel Plate”, Tribology Online, 12, 2 (2017) 42-48].

In some examples, the AC field applied is between 0.5 MHz and 5 MHz; at times, for EF51L best results achieved with about 1 MHz for a 50-300 μm thickness range liners.

Other parameters that may be involved when applying a triggering peeling energy include thermal expansion coefficient of liner, dielectric constant, IR absorption efficiency, and its magnetic property (e.g. when magnetic additives are added to the liner's composition).

In some examples of the presently disclosed subject matter, the triggered input comprises applying a steam beam of a food compatible acid, such as citric acid or of an alcohol, such as ethanol.

For example, it has been found that applying low concentrations of a food compatible acid, such as citric acid or acetic acid, weakened the surface adhesion of a liner comprising EF51L to the substrate. For example, it has been found that citric acid or acetic acid (e.g. 2-5% concentration) were suitable for weakening the bonding of EF51L to a metal substrate, without affecting the liner's integrity. Other food compatible acids that can be used in accordance with this example, include phosphoric acid, ascorbic acid, and others, as known in the food industry.

For example, it has been found that applying low concentrations of ethanol, weakened the surface adhesion of a liner comprising EF51L to a metal substrate, without affecting the liner's integrity.

In some examples, the method of removing the liner from the substrate involves a triggered input implemented by injecting pressurized gas into pre-fabricated zones/spaces/channels between the substrate and the liner causing at least partial detachment of the liner from the substrate, and removing the at least partially detached liner from the substrate.

In some examples, the method of removing the liner from the substrate involves a triggered input that comprises heating the liner to a temperature below melting temperature of the blend of components forming the liner.

In some examples, the heating of the liner is while the substrate is connected to a negative pole of an Alternating Current (AC) Radio Frequency (RF) generator and is subjected to an AC field as described above.

All definitions, as defined and used herein, should be understood to control over dictionary definitions, definitions in documents incorporated by reference, and/or ordinary meanings of the defined terms.

The term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range. In some embodiments, the term “about” refers to ±10%.

The indefinite articles “a” and “an” as used herein in the specification and in the claims, unless clearly indicated to the contrary, should be understood to mean “at least one.” It must be noted that, as used in this specification and the appended claims, the singular forms “a”, “an” and “the” include plural referents unless the content clearly dictates otherwise.

The phrase “and/or” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above.

Throughout this specification and the Examples and claims which follow, all transitional phrases such as “comprising,” “including,” “carrying,” “having,” “containing,” “involving,” “holding,” “composed of” and the like are to be understood to be open-ended, i.e., to mean including but not limited to. Specifically, it should understood to imply the inclusion of a stated integer or step or group of integers or steps but not the exclusion of any other integer or step or group of integers or steps. Only the transitional phrases “consisting of” and “consisting essentially of” shall be closed or semi-closed transitional phrases, respectively, as set forth in the United States Patent Office Manual of Patent Examining Procedures. More specifically, the terms “comprises”, “comprising”, “includes”, “including”, “having” and their conjugates mean “including but not limited to”. The term “consisting of” means “including and limited to”. The term “consisting essentially of” means that the powder, blends, methods etc may include additional components, steps and/or parts, but only if the additional components, steps and/or parts do not materially alter the basic and novel characteristics of the claimed subject matter.

It should be noted that various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub ranges as well as individual numerical values within that range. For example, description of a range such as from 10 to 60 should be considered to have specifically disclosed sub ranges such as from 10 to 30, from 10 to 40, from 10 to 50, from 20 to 40, from 20 to 60, from 30 to 60 etc., as well as individual numbers within that range, for example, 10, 20, 30, 40, 50, and 60. This applies regardless of the breadth of the range. Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

It is appreciated that certain features of the disclosure, which are, for clarity, described in the context of separate examples, may also be provided in combination in a single example. Conversely, various features of the present disclosure, which are, for brevity, described in the context of a single example, may also be provided separately or in any suitable sub combination or as suitable in any other described example of the present disclosure. Certain features described in the context of various examples are not to be considered essential features of those examples, unless the example is inoperative without those elements.

The following examples are representative of techniques employed by the inventors in carrying out aspects of the present invention. It should be appreciated that while these techniques are exemplary of preferred examples for the practice of the invention, those of skill in the art, in light of the present disclosure, will recognize that numerous modifications can be made without departing from the spirit and intended scope of the invention.

### DESCRIPTION OF NON-LIMITING EXAMPLES

### Example 1-Liner Formation

### Materials

For the purpose of preparing exemplary coatings, the following materials were used:
Mater-Bi EF51L—a Novamont brand name—a biodegradable and compostable bioplastic granulate composed of corn starch, vegetable oil derivatives, and biodegradable synthetic polyesters (Novamont, as described in International Patent Publication No. WO06/097353, WO06/097354, WO06/097353 WO06/097355, WO06/097356 the content of which are incorporated herein by reference)
PBAT—polybutylene adipate terephthalate (a biodegradable random copolymer, specifically a copolyester of adipic acid, 1,4-butanediol and terephthalic acid (from dimethyl terephthalate))

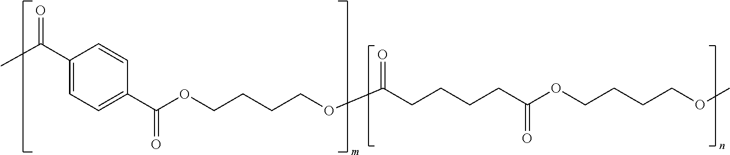

### Methods

### Powder Preparation

Four blends based on EF51L were prepared, each blend comprised a different amount of TiO₂, glycerol and PBAT as summarized in Table 1 below.

The blends were co-extruded in a twin screw extruder to allow intimate mixing of the components. The extrusion conditions were according to manufacturer's instructions.

TiO₂ was added to enhance the resulting liner's dielectric constant and thereby enhance the dielectric response of the liner, in the presence of an electric field.

PBAT and Glycerol were added in order to enhance the liner's elasticity. The elasticity can assist in the release of the liner by reducing the risk of tearing or rupturing of the liner when a peeling force is applied.

TABLE 1
powder blends

| Blend # | EF51L | TiO2 powder | Glycerol | PBAT |
|---|---|---|---|---|
| 1 | 99% | 1% | | |
| 2 | 97% | 3% | | |
| 3 | 90% | | | 10% |
| 4 | 80% | | 10% | 10% |

To enable grinding of the soft thermoplastic blends, pellets of the EF51L (as received from manufacturer) and pellets of each extruded blend were cooled down to a temperature (Tmill) of ~−50° C. using liquid nitrogen (LN₂) to receive frozen and stiff pellets. The frozen pellets were then cryogenic grinded using a commercially available small-scale grinder. The resulting powder was then filtered using any one or a combination of 200, 150, 100 and 75 microns sieves. For coating experiments (below) powder grinded into a grain size range of 50 to 200 micron was used and found to be compatible with the required liner performances, as further shown below.

### Substrate Liner Coating

### (A) Liner Formation Using Ceramic IR Source

The fine powder (75 to 200 micron) was applied by spraying on various stainless-steel samples: plate (5×4 inches), ruler like plates (5×1 inches) and lab size bowls (12 inch in diameter×2 inches depth). A manual electrostatic powder coating gun (ENCORE LT from NORDSON) was used. The deposited fine powder was then heated while on the substrate using ceramic IR heat sources (250W—for small substrate, 3 kW—for large substrate) from THERMOLINE, set at a power level applying up to 170° C. on the sprayed layer (being above the melting temperature of the powder which is nominally 167° C.), until the deposited powder turned into a continuous liner adhered onto the various metal substrate. The thickness of the resulting liner was in the range of 100-200 micron.

### (B)—Liner Formation Using Quartz IR Source

Quartz IR emitters (Heraeus Nobelight 60 cm carbon IR emitter at 500 W) peaking at 960° C. for effective absorption, is used—to minimize powder melting time duration.

Specifically, EF51L (Novamont) powder (100 to 200 μm grain size) was first analyzed for determining its spectral behavior: absorption and transmission, so as to determine for the appropriate window(s) with maximal absorbance at (which the operational power of the quartz emitter is to be controlled/tuned). The powder material's IR spectrum was obtained using FTIR—in the 3 to 10 μm range, and short and medium wavelengths—in the 0.5 to 2.5 μm range. Based on the analysis, it was determined that EF51L has a spectral window with maximal absorbance (60% absorbance) between 2.3 μm and 2.4 μm. Therefore, according to Wien's Law (determines at what wavelength the radiation of a blackbody peaks at) it was concluded that the filament temperature should be set to 960° C.

It was found that when using the above filament temperature, the time required for powder melting was 10 times shorter than the time required when using ceramic IR emitter.

Powder melting on large surface areas can be further accomplished using an array of quarts IR emitters.

### (C)—Liner Formation Using Module-Heaters Using Metal Foil IR Emitters.

Using, e.g. Krelus/Leister MINI G14-25 M) surface-shaped emitters, a temperature/wavelength choice is possible, enabling special array of such heaters, mounted to cover simultaneously large inner vessel's surface areas, and specifically—effective heating of corners (2D and 3D) which are hard to approach otherwise.

### Results

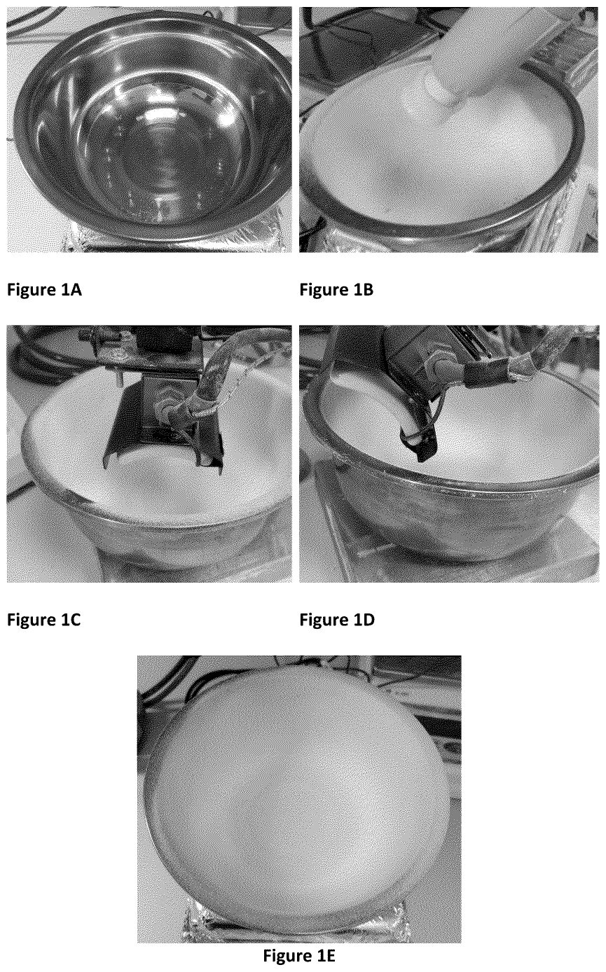

FIGS. 1A-1E show the sequence of steps taken for coating a stainless steel bowl, including the bowl before coating (FIG. 1A), Electrostatically spraying of the bowl (FIG. 1B), heating of the sprayed bowl using ceramic IR heater (at about 150° C.) (FIGS. 1C-1D), and the resulting liner coated bowl (FIG. 1E). In this non-limiting example, the IR device had a 30 cm² irradiation area.

To confirm that the adherence of the liner to the substrate is independent from the shape of the substrate, the coating process was repeated on additional stainless-steel items, with other dimensions and/or contours, including “rulers” (10×1 inches, 2 mm thick), shallow bowls (25 cm in diameter and 5 cm deep), and a kitchen-table-mixer's bowl (BOSCH MUM2).

The formation and adherence of the resulting liner onto a tested substrate was completed in a matter of minutes. When using stainless-steel plate as substrate, an area of 5×5 inches (150 sq. cm) was completely powder sprayed in about 10 seconds and subsequently heated until formation of a molten, to form, within about 5 minutes, the substrate adhered liner.

### Physical Properties

Physical properties of the resulting adhered liners were evaluated.

Specifically, the force needed to peel the liner was measured. This force represents the liner—substrate adhesion force. Without being bound by theory, it is believed that this property is important for at least one of the following:
a) The liner has to withstand the constraints of processing while masking the container's walls and remain intact and adhered in place. This property is determined at liner's production stage.
b) The liner has to be easily removable at the end of the processing. This feature is to be externally triggered.

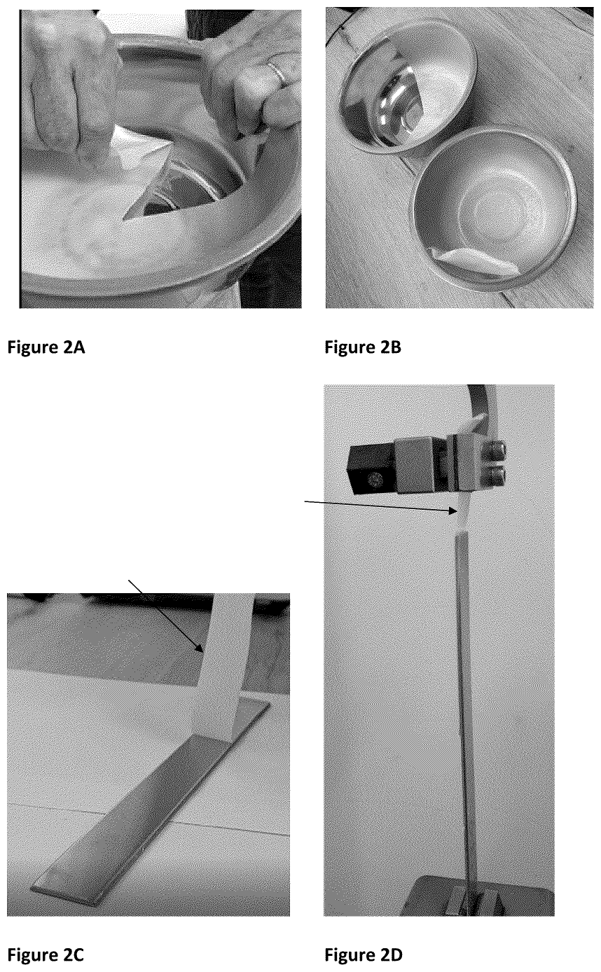

Peeling was conducted either manually, as shown in FIGS. 2A-2C or mechanically, as shown in FIG. 2D, whereby the extent of adhesion was evaluated qualitatively or using a tensile force measuring systems:
(1) a LLOYD machine—with sample confining temperature cell—to obtain temperature dependence of peeling values. At this time—easiest liner peeling temperature was found at 70° C., at peeling machine speed of 300 mm/min. It is noted that this temperature was determined after experimenting temperatures from −6° C. to 70° C. and the latter was found to provide best peeling performance still avoiding rupture while peeling.
(2) Testometric M500-50CT: to obtain quantitative peeling values at room temperature, speed 300 mm/min.

The above result sets a temperature value to consider while inserting ingredients into the processing surface: even if the raw materials are below the softening point of at least one component, the liner still will not de-bond, and there would be a need for mechanical force to complete full detachment.

Adhesion force measurements took into consideration that the measured force in this experimental setup is the sum of the peeling force and stretching force of the peeled liner. The peeling apparatus speed was selected to reflect mainly the peeling (and not the stretching) force. In all tests liner was removed as one complete cohesive piece, without tearing or cracks.

### Coated Item Use

The durability of the liner coating was evaluated on a kitchen table mixer (BOSCH MUM2) bowl. Specifically, the inner surface of a stainless-steel mixer bowl was coated as described above with EF51L powder ground to particles sizes of 75 to 200 micron, also as described above.

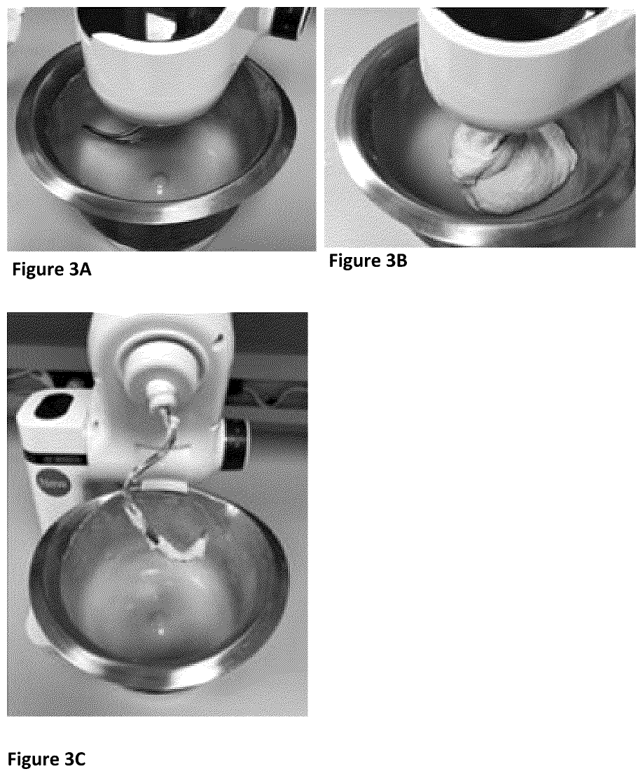

The bowl with the inner coating was then used for kneading dough. The coated bowl before, during and after kneading of the dough is shown in FIGS. 3A-3C. Specifically, the coated bowl was mounted onto a kitchen kneader, as shown in FIG. 3A, and the kneading dough took place, as shown in FIG. 3B.

It has been found that under regular operation of the kitchen kneader and during the dough kneading process, the inner liner coating remained stably adhered to the inner surface of the bowl, notwithstanding the friction applied thereto by the mixed dough, as shown in FIG. 3C.

### Example 2—Liner Removal

### (A) Liner Debonding Using an Electric Field

In order to facilitate a quick removal of the liner after material processing has been completed—a triggering mechanism was applied, that significantly reduced the adhesion force of the liner to the surface, enabling its easy peeling and removal of the liner without its rupturing. Removability/peel-ability of the liner coating was evaluated on the tested EF51L liner coatings.

The effect of different parameters on the adhesion and peel-ability of the tested liner from the substrate was evaluated.

### Electric Field

An electric field can disrupt the array of electric dipoles involved in determining the adhesion strength at the liner/surface interface. Specifically, electric field parameters were tested, and these included direct current (DC) or alternating current (AC), peak to peak voltage (Vpp), inter electrode distance, AC frequency—in the RF region, electrical field (E-field) strength (Vpp divided by inter electrode distance determining the field-V/m), and polarity (positive or negative polarity of the RF generator electrode attached to the coated substrate).

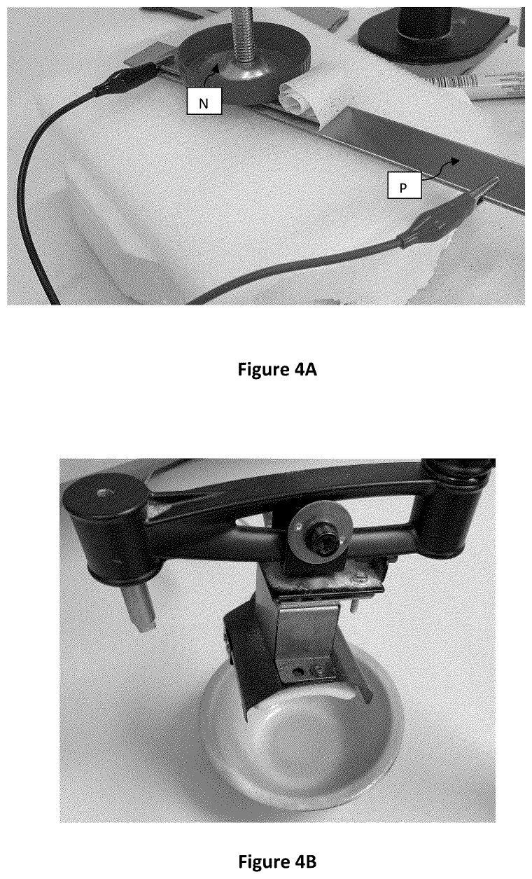

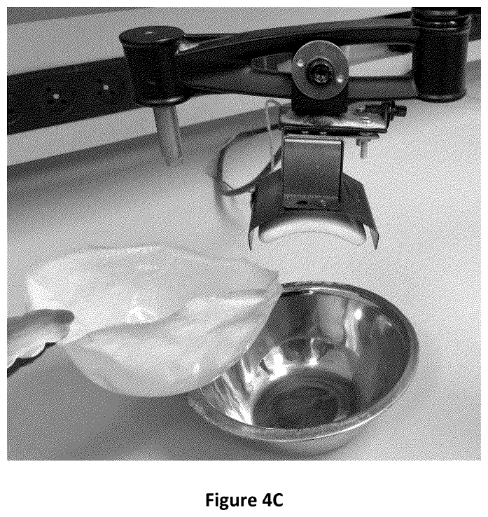

The above parameters were applied using a RIGOL model DG822 RF generator (0-25 MHz). To form the electric field an exposed metallic edge of a coated substrate was connected to one of the generator's poles, while an external opposite electrode plate was placed in front of the coated sample, connected to the opposite pole. For illustration, see FIG. 4A showing a field being applied between the negatively charged electrode plate (“N”) and the positively charged coated electrode plate (“P”). The distance between the electrode plates was about 5 mm.

Peeling was conducted either manually (FIG. 2A), whereby the extent of adhesion was evaluated qualitatively or using a tensile force measuring system (Testometric M500-50CT) to obtain quantitative peeling values, in which case the distance between the electrodes was about 5 mm. Specifically, different electric field configurations were applied for 12 minutes, on the EF51L-spray coated substrates.

Quantitative testing the effect of electric field on peel-ability was carried out at room temperature (22° C.).

Table 2 shows the best adhesion force reduction results achieved out of various field configurations experimented, for which a 35% peeling force reduction was achieved. As shown in Table 2, this was achieved with an AC field at 1 MHz frequency, Vpp=20V, coated substrate was at negative polarity, interelectrode gap was 5 mm. In Table 2, “REF” represents peeling force reference values (peeling without applying any field).

It has been found that liner thickness had also an effect on coating detachment (liner removal): the thicker the liner, the easier was the peeling without rupture.

TABLE 2
Field configuration and liner thickness
yielding maximal peeling force reduction

| Liner thickness | field | Peeling Force |
|---|---|---|
| (microns) | Configuration | (N/inch) |
| 110 | REF | 4 |
| 110 | REF | 3.7 |
| 210 | AC | 1.5 |
| 165 | AC | 2.9 |
| 115 | AC | 2.8 |

The results in Table 2 show that the adhesion of EF51L liner to the stainless-steel substrate was significantly reduced, and thus externally triggered-peel-ability was achieved when applying an AC field to the EF51L-coated substrate. In addition, the results presented in Table 2 show that liner thickness had also an effect and the thicker the liner, the less force was required in order to peel the liner from its substrate without it being ruptured.

### (B) Liner Debonding Using Heating

As mentioned above—the effect of temperature on the strength of adhesion was measured using a Lloyd tension measuring apparatus, determined at a Test and Return Speed of 300 mm/min.

For temperature dependent peeling force measurement (i.e. with or without temperature application) a ruler-like fully coated metal substrate was used (1 inch wide 10 inches long). Layout was vertical as shown in FIG. 2D. A lower gripper gripped one edge of the ruler and kept it in a fixed position, and an upper specially designed gripper gripped a manually pre peeled edge of the coated liner. The upper gripper was then driven at a constant speed of 300 mm/min. Peeling started immediately, and the resisting force (peeling force, plus stretching) was continuously monitored.

It has been found that the peel-ability increased with increased temperature. The results show that the forces reduced from 40N/inch (@(−6° C.)) to 8N/inch (@ Room Temperature ((@22° C.)) and down to 3N/inch (@70° C.) for the same liner thickness. This supports the conclusion that during industrial use, e.g. dough kneading processes (typically around room temperature) the liner coating will withstand the forces applied thereon and maintained adhered to the working industrial instrument.

For testing the effect of temperature on peel-ability of a liner from a bowl (such as that prepared as described above), in one experiment IR energy (~80° C.) was applied from different directions to expose the entire inner surface of the bowl to the heating for a total period of 10 minutes, as shown in FIG. 4B, causing an adhesion observed weakening. Exploring temperature-time tradeoff—a similar liner, at a thickness of 150-200 μm, was exposed to 40° C. for 10 days, revealing its easy removal in one integral and intact piece, as shown in FIG. 4C. The precise heat triggered removal working point was an optimization of temperature (40 to 80° C.), liner thickness (100 to 300 μm) and period of heat exposure (minutes to even days).

The results presented herein show that the fixation of the liner to the metal or metal containing substrate can be reversed by reducing the adhesion forces between the liner and the substrate and that the reversal of adhesion can be controlled, triggered and tuned using a combination of electric field and heating inputs, while taking into considerations, like liner composition, thickness etc.

### (C) Liner Debonding by Applying a Thermal Cooling Shock

Iced water is placed within a bowl carrying EF51L liner coating to an instant temperature drop on the liner. After less than 1 minute, the liner is easily removed from the bowl in one piece (not shown).
The bowl carrying EF5IL liner coating was exposed to a cold gas jet produced by Vortex gas jet (e.g. EX-AIR 150 cfm 3415 model Vortex Tube) to cause an instant temperature drop of the liner. After less than 1 minute, the liner was easily peeled off and removed from tested coated bowl and rulers of various sizes.
A compressed gas released through a nozzle or capillary has also provided a temperature drop shock for coated bowls. The gas can be any one of air, water vapor, nitrogen, carbon dioxide, helium etc.
A jet of liquid carbon dioxide (DMX RGB 3) or solid beam of dry ice (solid carbon dioxide, e.g. SMART dry ice blaster from Direct Industry) has also proven effective in creating adhesion releasing thermal shock. The blaster was operated at very low flow rate to avoid damage to the liner. Other cold liquids can be used as well.

### (D) Liner Debonding by IR Irradiation at Maximal Liner Transmission Wavelength

A bowl carrying EF5IL liner coating is exposed to IR irradiation at a wavelength (e.g. 3 μm) or wavelength range that fits the wavelength or wavelength range at which the material forming the liner has maximal or essentially maximal (e.g. close to 100%) transmission. Without being bound thereto, this effectively transports the heating energy to the liner-metal interface, creating debonding due to shear stress caused by the difference in liner/metal coefficients of thermal expansion. The liner is easily removable from the bowl. This method of removal is particularly useful when using laser beam at a selected maximum transmission wavelength.

### (E) Liner Debonding by Applying a Steam Beam of Food Compatible Acid

A bowl coated with EF51L liner was exposed to citric acid or acetic acid (at about 2-5% concentration). Both weak organic acids weakened the adhesive bonding forces and created a debonding effect of the polymeric liner from the metallic substrate.

### (F) Liner Debonding by Applying a Steam Beam of Food Compatible Ethanol

A bowl coated with EF51L liner was exposed to a steam beam of Ethanol (at about 10% concentration). The Ethanol steam weakened the adhesive bonding forces and created a debonding effect of the polymeric liner from the metallic substrate. It should be mentioned that the Ethanol concentration could vary from 5% where an effect is already noticeable and up to 100% ethanol.

1. A thermoplastic powder comprising in each grain a blend of components, at least one component comprising an aliphatic/aromatic copolyester (AAPE);
wherein the powder is suitable for being electrostatically sprayed onto a metal substrate or metal containing substrate and for forming onto said metal substrate a molten liner coating that is reversibly fixed to the substrate.

2. The thermoplastic powder of claim 1, wherein said AAPE comprises (a) an acid component comprises repeating units of a (i) polyfunctional aromatic acid and (ii) an aliphatic or cycloaliphatic acid and (b) diol component.

3. The thermoplastic powder of claim 2, wherein the polyfunctional aromatic acid is a dicarboxylic acid.

4. (canceled)

5. The thermoplastic powder of claim 2, wherein the aliphatic or cycloaliphatic acid is a hydroxyl acid or a dicarboxylic acid.

6. (canceled)

7. (canceled)

8. (canceled)

9. (canceled)

10. (canceled)

11. (canceled)

12. (canceled)

13. The thermoplastic powder of claim 1, wherein said blend of components comprises a metal oxide.

14. (canceled)

15. The thermoplastic powder of claim 1, wherein said blend of components comprises any one or combination of a phase change material (PCM).

16. (canceled)

17. The thermoplastic powder of claim 2, comprising at least 60 mol % of said acid component.

18. (canceled)

19. The thermoplastic powder of claim 1, wherein at least 50% of the grains are characterized by
having an irregular shape/non-spherical shape as viewed by an optical microscope; and
having a size above 50 μm.

20. (canceled)

21. The thermoplastic powder of claim 1, wherein said grain is characterized by at least one of:
having a grain size between about 50 μm and about 200 μm; and
having a grain density of about 1±0.3 gr/cm³.

22. (canceled)

23. A method of preparing a thermoplastic powder of claim 1, the method comprises providing pellets comprising a homogenous blend of components, at least one of the components comprising an aliphatic or cycloaliphatic polymer or co-polymer and subjecting the pellets to at least one cryogenic milling step to obtain powder grains.

24. (canceled)

25. (canceled)

26. (canceled)

27. (canceled)

28. (canceled)

29. The method of claim 23, comprising two or more cryogenic milling steps, until the pellets are downsized to a powder of d50 between 50 μm and 200 μm; and optionally sieving the powder.

30. A method of forming a thermoplastic liner over a metal or metal containing substrate, the method comprises spraying, followed by thermal treatment of a thermoplastic powder as defined in claim 1 onto said substrate.

31. (canceled)

32. (canceled)

33. (canceled)

34. (canceled)

35. An article comprising a metal or metal containing element having an exposed surface and a thermoplastic liner coating reversibly fixed to the exposed surface, the thermoplastic liner coating comprising a blend of components as defined in claim 1; said liner coating maintains its fixation and integrity over the exposed surface upon application of a processing stress imposing a force of said liner.

36. (canceled)

37. A method of removing a thermoplastic liner from a metal or metal containing substrate, the thermoplastic liner comprising a blend of components as defined in claim 1, the method comprises applying a triggered input configured to cause a change in at least said liner and pealing said liner in essentially one piece.

38. (canceled)

39. (canceled)

40. The method of claim 37, wherein said triggered input comprises applying a thermal shock onto said liner and/or onto said substate, said thermal shock is configured to create a temperature different of at least 10° C. between said liner and said substrate.

41. (canceled)

42. (canceled)

43. (canceled)

44. (canceled)

45. (canceled)

46. A method of removing a thermoplastic liner from a metal or metal containing substrate, the thermoplastic liner comprising a blend of components as defined in claim 1, the method comprises connecting the substrate to a negative pole of an Alternating Current (AC) Radio Frequency (RF) generator and subjecting the substrate to an AC field, while removing the thermoplastic liner from the substrate.

47. A method of removing a thermoplastic liner from a metal or metal containing substrate, the thermoplastic liner comprising a blend of components as defined in claim 1, the method comprising injecting pressurized gas into pre-fabricated channels between the substrate and the liner causing at least partial detachment of the liner from said substrate, and removing the at least partially detached liner from the substrate.

48. (canceled)

49. (canceled)

50. A method of removing a thermoplastic liner from a metal or metal containing substrate, the thermoplastic liner comprising a blend of components as defined in claim 1, the method comprising heating the liner to a temperature below melting temperature of the blend of components.

51. (canceled)

52. A method of removing a thermoplastic liner from a metal or metal containing substrate, the thermoplastic liner comprising a blend of components as defined in claim 1, the method comprising applying onto said liner a stream beam of a food compatible acid.

53. A method of removing a thermoplastic liner from a metal or metal containing substrate, the thermoplastic liner comprising a blend of components as defined in claim 1, the method comprising applying onto said liner a stream beam of a food compatible ethanol.
